(19) United States
(12) Patent Application Publication
(10) Pub. No.: US 2024/0116223 A1
(43) Pub. Date: Apr. 11, 2024

(54) METHOD OF AUTOMATEDLY HEATING, PRESS MOLDING AND REPLACING MULTIPLE MOLDS AT THE SAME TIME FOR INSOLE MATERIAL

(71) Applicants: Fu-Han Wei, Taichung City (TW); Sian-De Wei, Taichung City (TW)

(72) Inventors: Fu-Han Wei, Taichung City (TW); Sian-De Wei, Taichung City (TW)

(21) Appl. No.: 18/220,593

(22) Filed: Jul. 11, 2023

(30) Foreign Application Priority Data
Oct. 7, 2022 (TW) 111138254

(51) Int. Cl. B29C 43/58; B29C 43/04

(52) U.S. Cl. CPC B29C 43/58; B29C 43/04; B29L 2031/507

(57) ABSTRACT

A method of automatedly heating, press molding and replacing multiple molds for insole materials contains steps of: setting manufacture parameters by using a host control unit; setting a size and quantity of multiple insoles, a reloading weight of each mold, a heating temperature and a molding time of each insole in each mold; feeding the insole materials into the multiple molds by using the automatic material feeder to be heated and press molded; judging whether the molding time of each mold is more than or equal to a set time; waiting the molding time when the molding time of each mold is not more than or equal to the set time; taking the multiple insoles out of the multiple molds and judging whether the multiple insoles reach a set production quantity, and stopping production of the multiple insoles, when the insoles reach the set production quantity, thereby obtaining automatically production.

### TECHNICAL FIELD

The present disclosure relates to a method which is capable of automatedly heating, press molding and replacing multiple molds at the same time for insole materials.

### BACKGROUND

A conventional method of producing insoles contains steps of: loading insole materials on at least one mold of hot pressing machines, molding the at least one mold after moving the hot pressing machines upward and pressurizing the at least one mold to a predetermined pressure. Since the at least one mold is fixed on a worktable of the hot pressing machines to be maintained at a high temperature, the insole materials are molded based on patterns of the at least one mold. After a set molding time, the hot pressing machines are moved downward to demold and take out of the insoles from the at least one mold manually.

The hot pressing machines are mounted in a linear arrangement and contain at least one heating station based on using requirements.

However, such a producing method will have following defects:
1) Operators have to move among the hot pressing machines repeatedly to cause labor cost.
2) The insole materials have to be taken out of the hot pressing machines after unloading previous insole materials, thus causing long fabrication time and poor production efficiency.

The present invention has arisen to mitigate and/or obviate the afore-described disadvantages.

### SUMMARY

A primary aspect of the present invention is to provide a method which is capable of automatedly heating, press molding and replacing multiple molds at the same time for insole materials, thus enhancing production efficiency, reducing labor cost and fabrication time.

To obtain above-mentioned aspect, a method of automatedly heating, press molding and replacing multiple molds at the same time for insole materials provided by the present invention contains: providing a host control unit, an automatic material feeder, and the multiple molds.

The host control unit is used for setting manufacture parameters which include a size of multiple insoles, a quantity of the multiple insoles, a number of the multiple molds, a reloading weight of each mold, and a molding time of each insole, wherein the host control unit provides a corresponding program to the automatic material feeder based on the reloading weight of each insole so as to determine at least one mold of the multiple molds to load or unload the insole materials or the multiple insoles; wherein the method contains steps of:
first, setting the manufacture parameters by using the host control unit;
second, setting the size of the multiple insoles, the quantity of the multiple insoles, the reloading weight of each mold, a heating temperature and the molding time of each insole in each mold;
third, feeding the insole materials into the multiple molds by using the automatic material feeder to be heated and press molded;
fourth, judging whether the molding time of each mold is more than or equal to a set time;
fifth, waiting the molding time, when the molding time of each mold is not more than or equal to the set time;
sixth, taking the multiple insoles out of the multiple molds by using the automatic material feeder and judging whether the multiple insoles reach a set production quantity, wherein if not, the method is executed by returning the step of third; and
seventh, stopping production of the multiple insoles, when the insoles reach the set production quantity.

Preferably, the host control unit includes a computer, a programmable logic controller (PLC), and a human machine interface controller.

Preferably, the automatic material feeder loads or unloads the insole materials or the multiple insoles sequently according to a ratio of the reloading weight, when the automatic material feeder is broken or the multiple molds are replaced, the ratio of the reloading weight returns to zero.

Preferably, the automatic material feeder includes a mechanical arm, a linear slider, and a movable carrier.

Preferably, the multiple molds include at least one set mold and are fixed in any one of a linear arrangement, an arc-shape arrangement, a C-shaped arrangement, and a symmetrical arrangement.

Other objects and features will be in part apparent and in part pointed out hereinafter.

### BRIEF DESCRIPTION OF THE DRAWINGS

FIG. 1 is a flow chart of a method of automatedly heating, press molding and replacing multiple molds at the same time for insole materials according to a preferred embodiment of the present invention.

### DETAILED DESCRIPTION

A method of automatedly heating, press molding and replacing multiple molds at the same time for insole materials according to a preferred embodiment of the present invention comprises providing a host control unit, an automatic material feeder, and the multiple molds.

The host control unit includes a computer, a programmable logic controller (PLC), and a human machine interface controller. The host control unit is used for:
1) setting manufacture parameters, such as a size of multiple insoles, a quantity of the multiple insoles, a number of the multiple molds, a reloading weight of each mold, and a molding time of each insole;
2) providing a corresponding program to the automatic material feeder based on the reloading weight of each insole so as to determine at least one mold of the multiple molds to load or unload the insole materials or the multiple insoles.

The automatic material feeder includes a mechanical arm, a linear slider, and a movable carrier, wherein the automatic material feeder loads or unloads the insole materials or the multiple insoles sequently according to a ratio of the reloading weight, when the automatic material feeder is broken or the multiple molds are replaced, the ratio of the reloading weight returns to zero.

The multiple molds include at least one set mold and are fixed in any one of a linear arrangement, an arc-shape arrangement, a C-shaped arrangement, and a symmetrical arrangement.

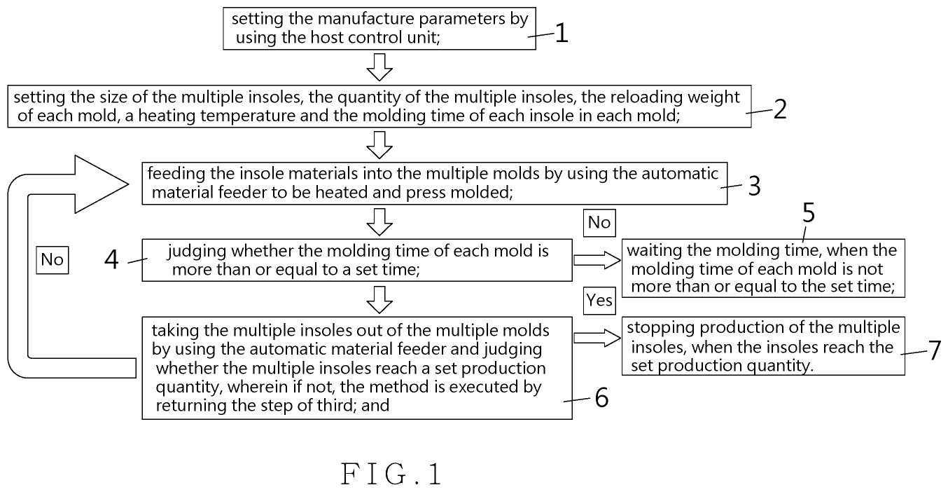

FIG. 1 is a flow chart of the method of automatedly heating, press molding and replacing multiple molds at the same time for the insole materials according to a preferred embodiment of the present invention. The method of the present invention comprises steps of:
first, providing the host control unit 1;
second, setting the size of the multiple insoles, the quantity of the multiple insoles, the reloading weight of each mold, a heating temperature and the molding time 2 of each insole in each mold;
third, feeding the insole materials into the multiple molds by using the automatic material feeder to be heated and press molded 3;
fourth, judging whether the molding time of each mold is more than or equal to a set time 4;
fifth, waiting the molding time 5, when the molding time of each mold is not more than or equal to the set time 4;
sixth, taking the multiple insoles out of the multiple molds by using the automatic material feeder and judging whether the multiple insoles reach a set production quantity 6, wherein if not, the method is executed by returning the step of third; and
seventh, stopping production 7 of the multiple insoles, when the insoles reach the set production quantity 6.

Thereby, the method of automatedly heating, press molding and replacing multiple molds at the same time for the insole materials is executed, wherein the method is completely used to produce the multiple insoles and is tested repeatedly.

When introducing elements of the present invention or the preferred embodiments thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the invention are achieved and other advantageous results attained.

As various changes could be made in the above constructions, products, and methods without departing from the scope of the invention, it is intended that all matter contained in the above description and shown in the accompanying drawings shall be interpreted as illustrative and not in a limiting sense.

What is claimed is:

1. A method of automatedly heating, press molding and replacing multiple molds at the same time for insole materials comprising providing a host control unit, an automatic material feeder, and the multiple molds;
wherein the host control unit is used for setting manufacture parameters which include a size of multiple insoles, a quantity of the multiple insoles, a number of the multiple molds, a reloading weight of each mold, and a molding time of each insole, wherein the host control unit provides a corresponding program to the automatic material feeder based on the reloading weight of each insole so as to determine at least one mold of the multiple molds to load or unload the insole materials or the multiple insoles; wherein the method comprises steps of:
first, setting the manufacture parameters by using the host control unit;
second, setting the size of the multiple insoles, the quantity of the multiple insoles, the reloading weight of each mold, a heating temperature and the molding time of each insole in each mold;
third, feeding the insole materials into the multiple molds by using the automatic material feeder to be heated and press molded;
fourth, judging whether the molding time of each mold is more than or equal to a set time;
fifth, waiting the molding time, when the molding time of each mold is not more than or equal to the set time;
sixth, taking the multiple insoles out of the multiple molds by using the automatic material feeder and judging whether the multiple insoles reach a set production quantity, wherein if not, the method is executed by returning the step of third; and
seventh, stopping production of the multiple insoles, when the insoles reach the set production quantity.

2. The method as claimed in claim 1, wherein the host control unit includes a computer, a programmable logic controller (PLC), and a human machine interface controller.

3. The method as claimed in claim 1, wherein the automatic material feeder loads or unloads the insole materials or the multiple insoles sequently according to a ratio of the reloading weight, when the automatic material feeder is broken or the multiple molds are replaced, the ratio of the reloading weight returns to zero.

4. The method as claimed in claim 1, wherein the automatic material feeder includes a mechanical arm, a linear slider, and a movable carrier.

5. The method as claimed in claim 1, wherein the multiple molds include at least one set mold and are fixed in any one of a linear arrangement, an arc-shape arrangement, a C-shaped arrangement, and a symmetrical arrangement.
